(19) United States
(12) Patent Application Publication
(10) Pub. No.: US 2005/0060219 A1
(43) Pub. Date: Mar. 17, 2005

(54) Analytical survey system

(76) Inventors: Franz Deitering, Mannheim (DE); Manfred Ostertag, Palo Alto, CA (US); Mathias Schoenecker, Forst (DE)

Correspondence Address: KENYON & KENYON, 1500 K STREET, N.W., SUITE 700, WASHINGTON, DC, 20005, US

(21) Appl. No.: 10/662,633

(22) Filed: Sep. 16, 2003

(51) Int. Cl. G06F 17/60

(52) U.S. Cl. 705/10

(57) ABSTRACT

Embodiments of the present invention provide integrated, flexible, automated and secure functionality for surveys such as E-surveys. In one embodiment, responsive to an indicator of business performance, a segment of E-survey results data corresponding to the indicator may be extracted. The extracted segment may be compared to an aggregate set of E-survey results data. Any E-survey results data from the extracted segment that statistically differ from responding results data from the aggregate set by a predetermined amount may be identified.

### TECHNICAL FIELD

The present invention relates to surveys. In particular, the present invention relates to electronic surveys that can be integrated with external data to provide real time business solutions.

### BACKGROUND OF THE INVENTION

Surveys such as employee surveys or electronic “E-surveys” are well known. Many companies use E-surveys to gather data from employees or other individuals related to various areas. Some of these companies still use the “paper and pencil” approach when conducting surveys. For example, surveys may be mailed out to a target group who complete the survey by hand and mail out the completed survey to the originator. The results of the survey may be tabulated and analyzed manually. This approach for collecting the data can be time and/or cost intensive. The process of assembling and/or organizing the data can be error prone, resulting in lower quality of data. Moreover, due to the labor intensive manner of completing and returning the completed survey, many in the target group may not complete and return the completed survey leading to incomplete or insufficient survey information.

Some companies utilize hosted survey or in-house custom developed electronic survey solutions that are not integrated into the enterprise resource planning (ERP) systems. Such conventional solutions do not provide desirable business information analysis and/or the integration of key business values with survey results. Moreover, these solutions may be expensive, may not provide the needed flexibility to target a participating group, may be error prone and/or may not provide sufficient security measures to maintain the integrity of the survey data.

Conventional systems may also lack output functionality such as organized storage and/or retrieval of survey feedback, analysis and reporting on survey feedback results, and/or authorization concept for survey results. In-house custom developed solutions can result in very high costs during development and on-going maintenance. At the same time, the organization can become highly dependent on a few specialists resulting in high risk of losing the experience if these experts were to leave the organization. Very often, measures to optimize business processes as part of the survey follow-up activity can fail.

In the increasing market of surveys such as electronic E-surveys, what is needed is a low cost and high quality solutions for survey administration, data collection, data analysis and/or integration. An E-survey solution that provides meaningful results that can be processed to provide valuable business information and/or real time business solutions is needed.

### BRIEF DESCRIPTION OF THE DRAWINGS

FIG. 1a is a block diagram illustrating how an E-survey target list may be generated in accordance with an embodiment of the present invention.

FIG. 1b is a block diagram illustrating how an E-survey may be transmitted to users based on user profiles in accordance with an embodiment of the present invention.

FIG. 2 is a system block diagram in accordance with an embodiment of the present invention.

FIG. 3 is a block diagram in accordance with an embodiment of the present invention.

FIG. 4 is a flowchart illustrating a method in accordance with an embodiment of the present invention.

FIG. 5 is a flowchart illustrating a method in accordance with an embodiment of the present invention.

### DETAILED DESCRIPTION

Embodiments of the present invention relate to an integrated survey system that incorporates business data to provide useful and/or valuable results. The integrated survey system can be configured for a targeted group of individuals. The results of a completed survey can be compared to and/or analyzed automatically with other data to generate reports and/or business solutions in accordance with embodiments of the present invention. For example, survey results may be compared with other data to provide comparison information that can be used to make management decisions. For example, such analysis may permit a business's management to quickly and effectively adjust workforce and/or processes to optimize business results. Moreover, in embodiments of the present invention, segments of the survey results may be compared with aggregate survey results and/or corresponding other segments of the survey results.

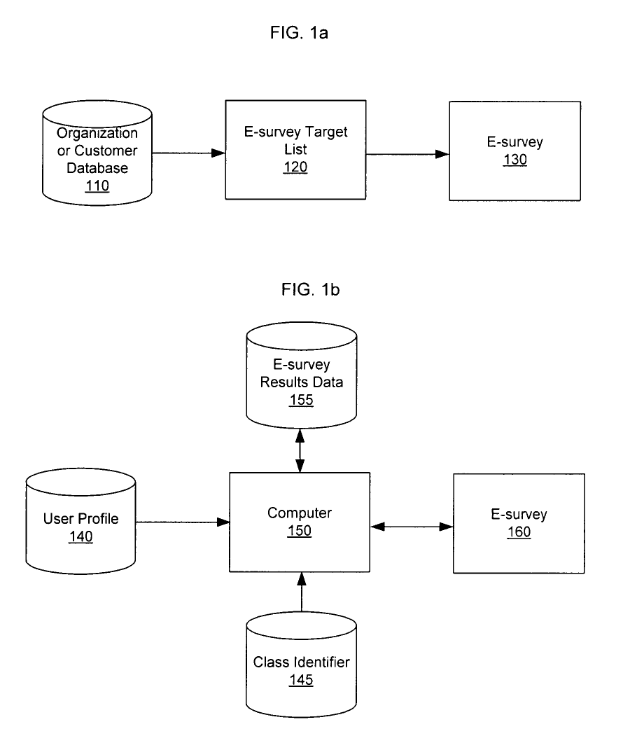

FIG. 1a is a block diagram illustrating how a target group may be chosen for a survey or E-survey in accordance with embodiments of the present invention. As shown in FIG. 1, an organization or customer database may identify employees or customers of an organization or the like. The database 110 may be searched to generate a target group for a particular survey. A E-survey target list 120 that includes the identities of individuals for the survey may be generated from the database 110 or another database. It is recognized that the E-survey target list 120 may also be generated manually by direct entry. Once the target list 120 is generated, a survey such as an E-survey may be provided to one or more individuals identified in the target list. In embodiments of the present invention, a user profile or the like may also be used to send surveys to a targeted group of individuals.

In one example, the database 110 may include names of a plurality of departments such as operations, marketing, administration, management, etc. Each department may include a plurality of employees such as staff, managers, officers, etc. In embodiments of the present invention, a target group may be selected for participation in an E-survey based on, for example, the department to which individuals in the group belong, individual titles, job description, salary, and/or any other criteria. The target group also can be chosen by randomly selecting a plurality of members in the organization. Names or other identifiers associated with individuals along with other information such as title, job description, department, etc. may be stored in the database 110 and may be selected by an operator of the E-survey system for participation in the E-survey.

In embodiments of the present invention, once an E-survey target list 120 has been generated, access to the E-survey 130 may be permitted to members of the target group identified in the list 120. It is recognized that, if the survey is anonymous, a unique survey identifier (ID) or the like may be generated for each survey and used to process and/or keep track of the survey in lieu of names of survey takers. In embodiments of the present invention, the E-survey may be e-mailed to members, may be made available via a web site, or may be sent by other means such other regular mail, etc. In some cases, members of the target group may be provided with or create a User ID and/or password that may permit access to a secure web site that may present and/or permit access to the E-survey.

Although reference is made specifically to employee surveys, it is recognized that embodiments of the present invention may be applied to any type of surveys or questionnaires that may be sent to customers, clients, and/or any other individuals or entities.

FIG. 1b is a block diagram illustrating how e-surveys may be transmitted based on user profiles. In embodiments of the present invention, a user's profile 140 and/or class identifiers 145 may be used to determine which users should receive an e-survey for completion. This profile may include a variety of different information related to the employee, customer, etc. Such information may include a name, address, employer, employment position, salary, department in which the person is employed, and/or any other information related to the employee. In another case, the information may be related to a customer such as where the customer likes to shop, type and/or brands or products the customer purchases, other information related to the purchasing habits of the customer and/or any other information related to the customer and/or marketing information. A computer 150 may compare a class identifier 145 with the user profile 140 to determine whether an e-survey should be transmitted to and/or be otherwise accessible by a user. The survey 160 may be transmitted to and/or be accessed by each user whose profile matches the class identifier. The survey may be sent via e-mail, regular may, may be accessible via a web site and/or may be transmitted in any other way. The completed survey or the survey results may be received from each user whose profile matches the class identifier. The results of the survey may be stored in an E-survey results database 155.

In embodiments of the present invention, security features may be activated so that an un-intended use of the integrated E-survey system can be prevented. In one example, the E-survey target list 120 and/or user profile may be used to prevent individuals that are not part of the targeted group from participating in the survey. The E-survey target list 120 and/or user profile may be checked every time a completed E-survey is submitted and only E-surveys that can be authenticated based on the target list 120 and/or user profile may be accepted as valid.

In another example, the system may prevent deliberate or inadvertent duplicates of completed E-surveys from being submitted by users of the system. This may be accomplished by, for example, comparing the unique survey IDs or other identification information on completed surveys with the unique survey IDs or other identification information stored in the E-survey target list 120. To provide further security, the unique survey IDs and/or other information may be encrypted. In this case, as completed E-surveys are submitted, the unique IDs may be flagged on the list 120 and no additional E-surveys with the same ID may be submitted and any duplicate surveys may be disregarded. Optionally or additionally, if duplicate E-surveys are submitted, all completed E-surveys from that individual may be discarded or flagged. It is recognized that additional features may be implemented to preserve the integrity of the E-survey system in accordance with embodiments of the present invention. It is further recognized that the names of individuals taking the surveys may also be used to provide the above described security features.

As completed E-surveys are received and/or validated, the E-survey results may be compiled and stored in a survey database, for example. The database may also contain other information such as historical E-survey data or such data may be contained in a separate database. The E-survey data can be processed and/or exported to other systems such as analytical systems and/or processes in accordance with embodiments of the present invention.

In embodiments of the present invention, E-survey results may be provided in the form of reports, raw data or the like to selected individuals and/or a group of individuals in a particular class such as HR (human resources) personnel, executive board members, managers, etc. Results can be sent to such individuals via e-mail, via web portal access, via regular mail and/or by any other means. Optionally or additionally, access to the E-survey results may be accessed via a web site based on created access rights and/or by using user IDs and passwords. Such access, IDs and/or passwords may be created by the user and/or by the system administrator. Accordingly, in embodiments of the present invention, authorized individuals can access results of the survey efficiently and securely. For example, by using an organization's management hierarchy and/or the organizational structure, access to E-survey results may be authorized and/or controlled. In one case, access rights may be created for all or some board members, managers, supervisors, members of a particular department, etc. so that access to the E-survey results by individuals belonging to these groups, for example, may be permitted.

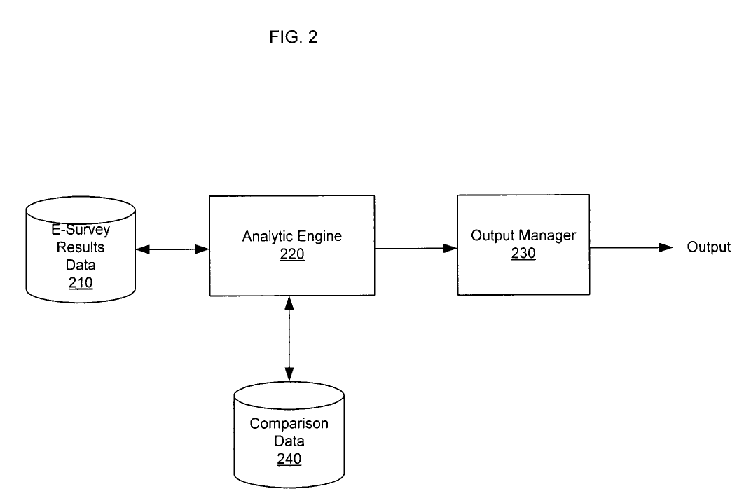

FIG. 2 is a block diagram illustrating an analytic E-survey system in accordance with embodiments of the present invention. FIG. 2 shows a database 210 that may contain E-survey results data, an analytic engine 220, comparison database 240, and/or an output manager 230. In one example, the comparison database 240 may contain internal historical survey data, historical business data external bench marks, internal benchmarks such as key performance indicators, and/or any other information. The analytic engine may include a computer processor that may compare data from the E-survey results database 210 that may contain current survey results with database 240 that may contain historical results from previous surveys or other information, for example. The output manager 230 may output the results of the comparison in the form of a spreadsheet or report. It is recognized that the analytic engine may compare segments of E-survey data in the database 210 with other segments of the E-survey data included in the database 210.

In one example, based on an input by a user, the analytic engine may extract a portion or segment of the data included in the results database 210. The input may be related to business performance and/or any other information. For example, the input may specify criteria such a period of time, a geographic region, internal expectations or benchmarks, external bench marks, customer satisfaction indicators, employee satisfaction indicators and/or any other information. Based on one or more input criteria, the analytic engine may search and extract a segment of the data included in the results database 210. In one case, this data may be compared to the aggregate data included in the results database 210 or other segments of data included in the results database 210. The analytic engine 220 may identify any E-survey data that may statistically differ from the aggregate or other segments of the data included in database 210 by more than a predetermined amount.

For example, an individual such as an operator having access rights to the E-survey results may wish to search for an employee or a group of employees that have employee satisfaction rates below a certain rate (e.g., less than 70%) and/or lower than an aggregate rate of all employees. The analytic engine 220 may search the entire results database 210 or a segment of the database 210 to identify employees that fit the criteria described by the operator. The analytic engine 220 may identify an individual or individuals such as employees of a particular department that may located in a certain geographical area that fit the criteria input by the operator. The operator may input additional information to perform further analysis on the survey results in database 210. For example, the operator may determine based on E-survey data and/or comparison data that the turnover rate for the group is also high as compared to the turnover rates for other departments in the organization and/or organization as a whole. In embodiments of the present invention, the operator can further analyze the information in the results database 210 using, for example, the analytic engine 220. For example, further analysis of the results database 210 may provide reasons for such low satisfaction rates and/or high turnover rates are due to lower compensation, poor management, etc. It is recognized that any type of analysis may be performed on E-survey results data 210 in accordance with embodiments of the present invention.

In another example, if a user wishes to compare survey results for a particular category with historical results in the category, the user may input the appropriate information into the analytic engine 220 via an input device (omitted). For example, if the user wishes to compare historical results related to employee satisfaction levels with recent E-survey data 210 related to the same, the user may make the appropriate selection via, for example, an appropriate display interface. The display interface may provide other fields of categories or information that the user may wish to compare with historical data. Examples of other information that the user may wish to compare may include employee compensation, days missed from work, hours worked, profits, revenue, cost, quality, turnover rates and/or any other information that may be based on survey data.

Going back to the example described above, once the user identifies the information for which a comparison is desired using, for example, the display interface and/or the input device, the processor, on which the analytic engine 220 may operate, may retrieve data related to employee satisfaction levels from the comparison data 240 with the E-survey data 210. The data may be directly derived from answers to survey questions related to, for example, employee satisfaction and/or the data may be determined based on information such as turnover rates in a particular department or any other information. Such information related to employee satisfaction, for example, may be retrieved and a comparison between related data may be made by, for example, the analytic engine 220. The analytic engine 220 may compare similar fields of the historic data 240 with the recent E-survey data 210.

It is recognized that a computer or other processing device on which embodiments of the present invention may be processed, may contain the appropriate software and/or hardware to carry out the functionality as described herein. For example, if the user desires a comparison of, as described above, employee satisfaction levels, the computer can search the appropriate databases where data related to satisfaction levels is stored and retrieve such data. Appropriate fields in the databases such as databases 210 and 240 may be searched for data related to employee satisfaction levels. A program or macro may be created that may specify the fields to search based on the type of information required. For example, if employee satisfaction ratings is required, of course fields that have specific data related to satisfaction ratings such as answers to survey questions may be searched and retrieved, in addition to other information such as employee turnover rates, compensation, morale and/or any other information that may be related or may provide insight to the satisfaction of employees.

In embodiments of the present invention, the user may input, for example, a time frame of the comparison data as well as the recent data. For example, the user may specify that data for the last five (5) years should be compared with recent survey data. Of course, the user may specify other parameters such as geographic regions, key performance indicators, internal and/or external benchmarks, and/or any other information related to the data requested. As the appropriate information is identified and retrieved from the results database 210 and/or the comparison and/or historical data, a comparison may be presented to the user. The computer system may retrieve appropriate data and, for example, a report in the form of a spreadsheet and/or a graph showing, for example, employee satisfaction ratings for the current year as compared with previous may be generated in accordance with embodiments of the present invention and output via output manager 230. Based on the collected information, the information may be sorted and/or other reports may be generated such as a report showing groups, departments, etc. that had the highest or lowest illness rates. Of course, other statistical or analytical information may be derived from the collected survey information and/or the historical information. As indicated above, based on the survey results data and/or comparison data, the analytic engine 220 may identify data that may statistically differ from aggregate or other data based on a predetermined amount, for example.

It is recognized that the comparison data 240, survey data 210 and/or any other type of data as described herein may reside in one or more storage memories. Such memories may be stand alone storage devices and/or may be incorporated in a single computer system or may be distributed among various systems.

In another example, the E-survey results may be benchmarked to or compared with other data such as external data and/or internal data that may be important for management and/or organization purposes. For example, the external data may be expected data relating to questions included in the survey. For example, turnover rates, determined based on current survey data, for a particular section or department of a corporation, may be compared with expected turnover rates for the corresponding section or department and an output may be provided in the form of a report or the like. Management can look at such comparisons and/or other statistical information to determine whether a potential problem may exist based on given information. Moreover, the E-survey results may be analyzed to determine a link to other business key values such as sales revenue, turn over rate, profit, cost, quality, customer satisfaction, illness rates, etc.

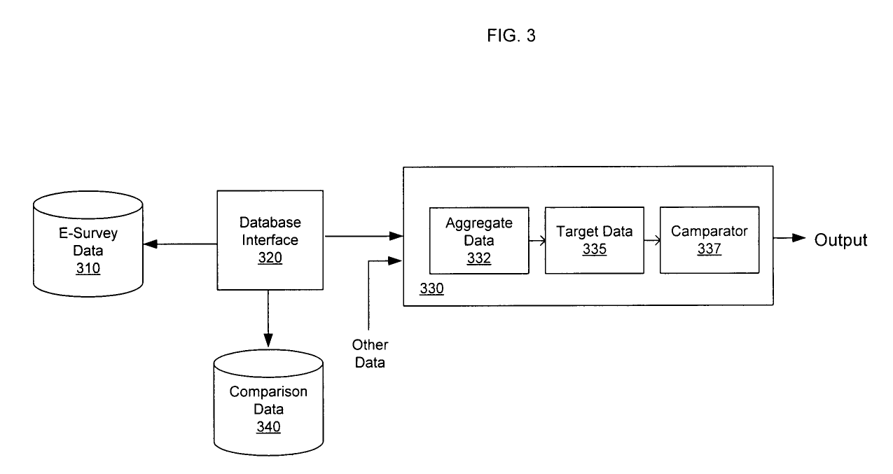

As shown in FIG. 3, embodiments of the present invention can be applied to business solutions employing strategic enterprise management (SEM) planning that may be linked to a company's strategy. Embodiments of the present invention may provide a system where survey data may be applied to analyze business data and/or present useful business information that are geared towards a company's SEM plan. As shown in FIG. 3, a database interface 320 may retrieve E-survey data from database 310, and/or other data such as comparison data from database 340. The interface 320 may be used to retrieve E-survey data 310 and/or other data 340. In embodiments of the present invention, the E-survey results data and/or any other data may be aggregated into a business information warehouse (BW). In embodiments of the present invention, the E-survey results data 310, for example, may be analyzed to determine what data should be analyzed to set goals to meet the SEM plan's objectives and/or to determine whether the SEM plan adjective are being met. The interface 320 may input data to exemplary SEM processing chain 330 that may compare and/or analyze the data in accordance with embodiments of the preset invention.

In embodiments of the present invention, the comparison data in database 340 may be related external benchmarks or expectations, key performance indicators (e.g., internal benchmarks), historical data and/or any other type of data. It is recognized that databases 310 and 340 may be a single database and/or may be a plurality of distributed databases. In one example, the interface 320 may search the E-survey database 310 and/or database 340 for information related to turnover rates, profits, skill levels of employees, number of employees, etc.

The system shown in FIG. 3 may use current survey data as well as historical data to observe trends and apply such analysis to management planning using, for example, the process shown in the SEM processing chain 330. In one example, a company may set an internal SEM goal to grow by 15% in the U.S. market over the course of 12 months. To achieve this goal, it may be determined that, for example, there will be need to increase the workforce in the designated geographic area by 10% or so. In accordance with embodiments of the present invention, the analytical E-survey system may be used to determine which area of the company need attention to meet the SEM objectives and/or to monitor that progress on such objectives is being made based on survey results and/or other comparison data, for example. In accordance with embodiments of the present invention, analytical E-survey system may be used to bring the strategy of a department most related to the company's SEM strategy, such as human resources (HR) in this case, in line with the strategy of the company overall so that the business objectives can be reached.

In one example, the SEM chain 330 may process data from the interface 320 as well as other data. The interface 320 may generate assembled data 332 which may be compared with, for example, target data 335 using comparator 337. In one example, the may analyze the various data including the survey data 310 and/or the comparison data to determine which areas of the company need focus in order to meet the company's strategic goals. For example, it may be determined that employee turnover rate for a particular location or department is higher than other offices and/or a predetermined number such as 20%, for example. Accordingly, the E-survey data 310 may be analyzed to determine reasons why the turnover rate is high. For example, the survey results may reveal that the employee satisfaction rate is low, employees are questioning the abilities of the leadership, employees think that management lacks vision, employees are not compensated sufficiently, employees are showing an intention to leave and/or any other information that may indicate why people are leaving the company and/or are planning on leaving.

In embodiments of the present invention, the survey data and/or other data may be aggregated and/or indices or targets may be generated to determine whether SEM goals are being met based on, for example, key performance indicators using processing chain 330. Key performance indicators may be income, profits, employee turnover rates and/or any other information that may be key or important in assessing the performance of a company and/or department. The analytical survey system on the present invention may determine what the targets 335 should be for the various information collected such as turnover rates, employee satisfaction rates, and/or any other information gathered from the survey results and/or comparison data based on the company's strategic objectives. These targets may be compared, by the comparator 337, with the aggregate survey data and/or other data to indicate whether a company's SEM goals are being met. If goals are not being met, survey data may be analyzed to determine which of the various areas related to questions being surveyed are not achieving the desired results and/or meeting expectation. For example, if turnover rates are still high, the survey results may be analyzed to determine whether employees are dissatisfied with working conditions, leadership vision, leadership strategy, compensation and/or other reasons related to increased and/or abnormal business conditions such as abnormal turnover rates.

The SEM chain 330 may use a balanced scorecard approach that analyzes the survey data based on a plurality of factors such as financial data, customer satisfaction ratings, employee satisfaction ratings, key processes, and/or other factors. This approach may be used to monitor that the company's SEM objectives are being pursued with a balanced approach. For example, the growth of the company should be achieved while maintaining other factors such as employee satisfaction rates, productivity, etc. so that these factors are not sacrificed for increased productivity and/or profits. Additionally, data may be analyzed using the management by objective process to verify that management objectives are being met. Based on earlier analysis, performance appraisals for management may be generated to determine appropriate levels of compensation.

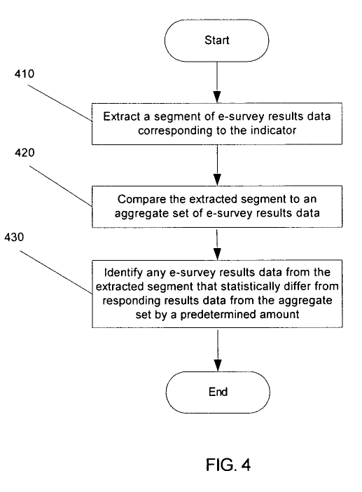

FIG. 4 is a flow chart illustrating a method in accordance with an embodiment of the present invention. A segment of E-survey results data corresponding to the indicator may be extracted, as shown in box 410. The E-survey results may be segmented in response to an indicator of business performance. The indicator may identify, for example, an organizational unit of a business that may be experiencing anomalous performance. The indicator may be period of time, geographic region, pey performance indicator, customer satisfaction indicator, employee satisfaction indicator and/or any other parameter. The extracted segment may be compared to an aggregate set of E-survey results data, as shown in box 420. Any E-survey results data from the extracted segment that statistically differ from responding results data from the aggregate set by a predetermined amount may be identified, as shown in box 430.

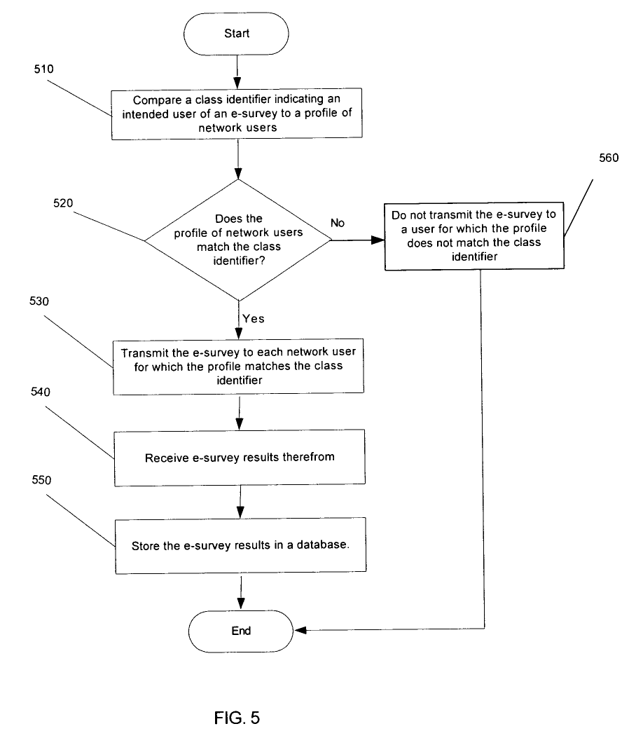

FIG. 5 is a flow chart illustrating a method in accordance with an embodiment of the present invention. The method may be performed in a single computer or in a plurality of computers. A class identifier indicating an intended user of an E-survey may be compared to a profile of network users, as shown in box 510. If the profile of network users matches the class identifier, an E-survey may be transmitted to each network user for which the profile matches the class identifier, as shown in boxes 520-530. In embodiments of the present invention, the E-survey may be transmitted by e-mail, web page, regular mail and/or any other technique may be used to transmit E-surveys.

As shown in box 560, the E-survey is not transmitted to any user for which the profile does not match the class identifier.

As shown in boxes 540 and 550, the E-survey results may be received and the E-survey results may be stored in a database. The survey results may be collected and sorted and/or saved in a database such as database 210, as shown in FIG. 2. The database 210 may be located in any type of data storage device or memory.

In embodiments of the present invention, a target list may be generated and/or used to identify an individual or a target group of individuals who should be surveyed or polled. The target list may include unique identifiers, names, occupation, employment titles, department identifiers, and/or other information to identify individuals to be surveyed. The survey results data may be received from the individuals in response. The information identifying individuals associated with the received results may be checked to confirm that only a single response is received from each individual identified in the defined target group. If only single response is received, the received results of the poll may be validated. If more than one response is received from a single individual, the received results of the poll may be invalidated. In the latter case, the results may be completely thrown out and the individual may not be allowed to participate in the poll or another poll may be sent to the individual in included in the target list. In another embodiment, the individual may be notified and/or requested to only submit a single survey result.

It is recognized that embodiments of the present invention may be processed in a standalone and/or network computer. A database such as database 210 and/or 240 may be searched for the appropriate data as specified by an input and/or indicator. It is recognized that the various databases as described herein may be located in any type of data storage device or memory.

In embodiments of the invention, it may be possible to dynamically aggregate specific items, for a specific person in different languages. For example, if a survey or questionnaire includes basic general items, strategic items of the country, specific items for managers, and special items for sales people, a sales manager in Switzerland, for example, may get in four languages these specific items in his questionnaire with a choice of language between German, English, Italian and French.

In embodiments of the present invention, survey questions may be dynamically updated based on the answers of the previous questions. This may be done using predetermined questions and/or artificial intelligence.

Embodiments of the present invention provide integrated, flexible, automated and secure functionality for E-surveys as well as other types of surveys that may offer simplified and efficient preparation and implementation, costs savings, and reduced administration time. The surveys can be easily customized to reflect personalized layout and design choices, among other features. The invention may provide direct integration with existing enterprise resource planning (ERP) processes, organizational management information as well as automated processing that may greatly increase speed, data quality and accuracy. The invention may reduce cost of data collection and/or analysis in comparison with a traditional paper and pencil approaches or in-house custom solutions. The invention may provide higher acceptance and/or return rates because of built in features such as return rate tickers.

As described above, the invention combines statistical analyses with other business key values to provide more valuable results. For example, linking results of an E-Survey with other business key values such as employee turn over rate, retention, productivity and/or revenue, the value of the survey may increase significantly for top management.

Embodiments of the present invention may be used for all types of surveys such as census employee surveys, strategic pulse surveys, ad hoc surveys (to provide e.g., feedback on sales for a new product; pre-merger and post-merger integration, etc.), surveys to identify training needs, and/or any other type of survey.

Several embodiments of the present invention are specifically illustrated and described herein. However, it will be appreciated that modifications and variations of the present invention are covered by the above teachings and within the purview of the appended claims without departing from the spirit and intended scope of the invention.

1. A automated personnel evaluation method, comprising:
responsive to an indicator of business performance, extracting a segment of E-survey results data corresponding to the indicator;
comparing the extracted segment to an aggregate set of E-survey results data;
identifying any E-survey results data from the extracted segment that statistically differ from responding results data from the aggregate set by a predetermined amount.

2. The method of claim 1, wherein the indicator identifies an organizational unit of a business experiencing anomalous performance.

3. The method of claim 1, wherein the indicator identifies a period of time.

4. The method of claim 1, wherein the indicator identifies a geographic region.

5. The method of claim 1, wherein the indicator is a key performance indicator.

6. The method of claim 1, wherein the indicator is a customer satisfaction indicator.

7. The method of claim 1, wherein the indicator is an employee satisfaction indicator.

8. The method of claim 1, wherein the aggregate set is E-survey results data for a business and the extracted segment is a portion of the aggregate set.

9. The method of claim 8, wherein the aggregate set is E-survey results data for a market in which the business participates.

10. The method of claim 1, further comprising:
comparing the extracted segment of E-survey results data to historical data.

11. The method of claim 1, further comprising:
comparing the extracted segment of E-survey results data to external benchmarks.

12. The method of claim 1, further comprising:
comparing the extracted segment of E-survey results data to key performance indicators.

13. The method of claim 1, further comprising:
comparing the extracted segment of E-survey results data to at least one of sales revenues, turn over rates, profit statistics, cost statistics, quality statistics, customer satisfaction rates and illness rates.

14. An automated E-survey method, comprising:
comparing a class identifier indicating an intended user of an E-survey to a profile of network users;
transmitting the E-survey to each network user for which the profile matches the class identifier;
receiving the E-survey results therefrom; and
storing the E-survey results in a database.

15. The method of claim 14, further comprising:
transmitting the E-survey to each network user identified in a target list of users.

16. The method of claim 14, further comprising:
validating E-survey results from only users identified in the target list of users.

17. The method of claim 14, further comprising:
comparing an access identifier with contents of a results access profile;
permitting access to the E-survey results to an administrator for which the access profile matches the access parameter.

18. The method of claim 14, further comprising:
validating the E-survey results from each network user only if the profile matches the class identifier.

19. The method of claim 14, further comprising:
validating the E-survey results from each network user only if a single response is received from each network user.

20. The method of claim 14, further comprising:
discarding the E-survey results from a network user if more than one response is received from the network user.

21. A system comprising:
a survey database to store survey data collected from a survey completed by a plurality of users identified in a survey target list;
an analytic engine to apply a comparison function to the collected survey data; and
an output manager to generate a result based on the applied comparison function.

22. The system of claim 21, wherein the output manager is to permit access to the generated result based on pre-determined access rights.

23. The system of claim 21, wherein the analytic engine is to:
responsive to an input, extract a segment of the collected survey data; and
apply the comparison function to the extracted segment.

24. The system of claim 23, wherein the comparison function applied by the analytic engine is to:
compare the extracted segment of the survey data to an aggregate set of survey data stored in the survey database.

25. The method of claim 24, wherein the aggregate set is survey data for a business and the extracted segment is a portion of the aggregate set.

26. The method of claim 25, wherein the aggregate set is survey data for a market in which the business participates.

27. The system of claim 23, further comprises:
an business information database to store business information, wherein responsive to the input, the analytic engine is to extract a segment of the business information stored in the business information database and is to compare the extracted segment of the survey data to the extracted segment of the business information.

28. The system of claim 27, wherein the extracted segment of the business information relates to historical information.

29. The system of claim 27, wherein the extracted segment of the business information relates to external bench marks.

30. The system of claim 27, wherein the extracted segment of the business information relates to key performance indicators.

31. The system of claim 27, wherein extracted segment of the business information relates to at least one of sales revenues, turn over rates, profit statistics, cost statistics, quality statistics, customer satisfaction rates and illness rates.

32. The system of claim 23, wherein the input identifies a period of time.

33. The system of claim 23, wherein the input identifies a geographic region.

34. The system of claim 23, wherein the input is a key performance indicator.

35. The system of claim 23, wherein the input is a customer satisfaction indicator.

36. A method for analysis of survey data, comprising:
receiving a comparison parameter input from a user;
retrieving data from a comparison database based on the input;
retrieving a segment of survey results data from a survey results database based on the input;
comparing the retrieved comparison data with the retrieved segment of survey results data; and
generating an output based on the comparison.

37. The method of claim 36, further comprising:
sorting the collected survey data based on questions included in a survey.

38. The method of claim 36, wherein the comparison parameter includes one or more data categories to be compared.

39. The method of claim 36, wherein the comparison parameter includes an output format for the output.

40. A survey results data evaluation method, comprising:
responsive to an indicator of business performance, extracting a segment of E-survey results data corresponding to the indicator;
comparing the extracted segment of E-survey results data to business data;
analyzing the segment of the E-survey results data and the business data using a balanced scorecard approach;
based on the analysis, identifying any E-survey results data from the extracted segment that is out of balance with respect to the business data.

41. The data evaluation method of claim 40, wherein the business data includes key performance indicators.

42. The data evaluation method of claim 40, wherein the business data includes profit statistics.

43. The data evaluation method of claim 40, wherein the business data includes productivity statistics.

44. The data evaluation method of claim 40, wherein the extracted segment of E-survey results data relates to employee satisfaction rates.

45. The data evaluation method of claim 40, wherein the extracted segment of E-survey results data relates to customer satisfaction rates.

46. The data evaluation method of claim 40, wherein the extracted segment of E-survey results data relates to employee satisfaction rates.

47. A method comprising:
receiving strategic enterprise management objectives;
extracting collected e-survey data based on the received management objectives;
determining one or more targets based on the received management objectives;
comparing the extracted e-survey data with the targets to determine whether the one or more targets are being met;
identifying the one or more targets that are not being met.

48. The method of claim 47, further comprising:
determining the one or more targets based on key performance indicators.

49. The method of claim 48, wherein the key performance indicators include at least one of profits, income, and employee turnover rates.
